(19) United States
(12) Patent Application Publication
(10) Pub. No.: US 2006/0001516 A1
(43) Pub. Date: Jan. 5, 2006

(54) Symmetrical phase shifting fork transformer

(76) Inventors: Alexander Mazur, Livingston, NJ (US); John Wilus, West Windsor, NJ (US)

Correspondence Address: William Squire, Esq.;c/o Carella, Byrne, Bain, Gilfillan, Cecchi,, Stewart & Olstein, 5 Becker Farm Road, Roseland, NJ, 07068, US

(21) Appl. No.: 11/157,016

(22) Filed: Jun. 20, 2005

Related U.S. Application Data
(60) Provisional application No. 60/584,683, filed on Jul. 1, 2004.

(51) Int. Cl. H01F 30/12

(52) U.S. Cl. 336/5

(57) ABSTRACT

A fork autotransformer has a symmetrically arranged annular array of legs manifesting each phase of a three phase transformer. Each leg has a core about which three layers of windings are wound. The inner and outer windings are zig windings and the middle layer is a winding having one end connected to a junction of the zig windings as a power input and the other end connected to an end of the same winding of the other phases at a neutral point. Top and bottom yokes are magnetically coupled to, but are in electrical conductive isolation to, the cores. A Y-shaped clamp assembly clamps the yokes to the cores. The yokes are spaced from the cores to minimize even harmonic distortion using an insulating layer between the yokes and cores. No delta winding is needed as triplin harmonic flux is coupled from the cores to the yokes and circulates harmlessly in the yokes minimizing triplin harmonic distortion at the input lines while the insulation spacer between the yokes and cores minimizes even harmonics eliminating the need for input line reactors. The windings are wound in layers about the cores with spacers forming air cooling ducts with each other and the respective cores.

This application claims the benefit of provisional application Ser. No. 60/584,683 filed Jul. 1, 2004 and incorporated in its entirety herein.

### BACKGROUND OF THE INVENTION

This invention relates to phase shifting fork transformers, sometimes referred to as AC/DC converters, and more particularly, to a fork transformer with minimum third harmonic and multiples thereof distortion at its outputs.

U.S. Pat. No. 5,455,759 to Paice, incorporated in its entirety by reference herein, discloses a symmetrical phase-shifting, fork transformer. However, this patent does not disclose or teach one of ordinary skill the details of the mechanical structure of the associated transformer used with the disclosed windings. The patent discloses what is referred to as a zig winding connected to a referred to teaser winding (which in the alternative may also be referred to as a zig winding) at a junction forming a power input terminal. A long winding has one end coupled to the junction of the zig winding and the teaser winding at the input terminal. The long winding may be tapped to form two series connected coils wherein an output terminal is connected to the tapping. The other end of the long winding is connected to like ends of other long windings of the other two phases of the three phase system at a neutral point. The zig and teaser windings are each disclosed in a further embodiment as forming a series connected auxiliary winding and an extender winding with the junction therebetween forming an output. The zig and teaser windings are wound about the core of the next adjacent so called clockwise and counter-clock wise positioned cores of the three phases. Other embodiments are also disclosed.

Further disclosed is a closed, but unconnected delta winding. The delta winding comprises three series connected windings with each winding wound about the core of a different corresponding leg of the three phase system and forming a closed loop independent of the other windings and not connected to the other windings. This delta winding serves an important function of siphoning off third harmonics and multiples thereof referred to as triplin harmonics by acting as a sink for these harmonics. These harmonics induce a current in the delta winding which current circulates harmlessly in the delta winding. Without the delta winding the triplin harmonics would generate undesired currents in the outputs and detrimentally affect the operation of the transformer.

These transformers are used to apply power to AC/DC converters forming 12, 18 and 24 pulse output signals as a result of rectification of the output AC signals. The earlier transformers typically require a minimum of five windings per leg as shown by Paice, to provide acceptable performance. One of these windings is used to form the delta winding. The delta windings provide a path in which induced currents from the third harmonics and multiples thereof flow thereby minimizing distortion at the outpputs.

Typical prior art transformers physically are constructed with the cores of the three phases arranged in a linear array. The cores and surrounding windings are secured to a common connection structure. These arrays are standard in the transformer industry including the construction of fork transformers having windings as disclosed by Paice.

The present inventors recognize that the delta winding adds cost to the transformer and also the need to minimize total harmonic distortion to minimize the need for input and output line reactors by the user of such transformers as required in the prior art transformers and which reactors also add to the cost of the system. The inventors recognize a need for an improved transformer without the need for a delta winding for the fork transformer and for a transformer with improved input and output characteristics wherein the need for input line reactors is not required providing improved lower cost operation by users of the improved transformer. The present inventors recognize that the linear array of the three phases of the transformer windings and core require the desired delta winding for minimizing the effects of the triplin harmonics. The present inventors recognize by providing the three phases in an annular array of symmetrical phase legs of cores and associated windings rather than in a linear array, the need for the delta winding can be eliminated by circulating the flux fields manifesting the triplin harmonics in annular yokes magnetically coupled to the cores rather than circulating the currents generated by such harmonics in a closed delta winding. This results in a transformer needing only a minimum of four windings per leg rather than five as in the prior art.

A three phase fork transformer according to an embodiment of the present invention comprises a symmetrical wye arrangement of three like transformer cores. A plurality of windings are associated with each core forming a fork transformer with the cores. Top and bottom yokes are secured to respective corresponding opposite top and bottom ends of each of the cores, the yokes being coupled to the windings and cores to receive and circulate therein third harmonic triplin generated fields generated by the windings and cores.

A fork three phase transformer according to another aspect of the present invention provides a symmetrical arrangement of three cores and associated windings coupled to top and bottom yokes which serve to receive and circulate therein the third harmonic triplin fields without the need for a delta winding. This arrangement includes electrically conductive isolation gaps between the cores and the yokes which also minimizes even harmonics reducing the need for input line reactors.

A three phase fork transformer according to a further aspect of the present invention comprises a symmetrical wye arrangement of three like transformer cores; a plurality of windings associated with each core forming a fork transformer with the cores; and annular top and bottom yokes secured to respective corresponding opposite top and bottom ends of each of the cores, the yokes being magnetically coupled to the windings and cores to receive and circulate therein flux formed by third harmonic triplin fields generated by the windings and cores.

A phase shifting three phase wye connected AC/DC fork transformer according to a further aspect comprises a plurality of like transformer magnetizable cores each having a top and a bottom. The cores each correspond to a different phase of the transformer and are arranged symmetrically about a central longitudinal axis. A plurality of windings are wound about each core, the windings of each core being substantially identical to the windings of each other core, the windings of each core being symmetrically arranged relative to the windings of each other core relative to the axis, the windings on each core comprising clockwise and counter clockwise zig windings connected to each other at a junction, and at least one central winding having one end coupled to the zig junction and its other end coupled to the same end of other central windings of each phase at a neutral point forming the fork transformer, the plurality of windings on each core and each core creating magnetic flux manifesting triplin harmonics. A yoke of magnetizable material is secured to each core at the core respective top and bottom, the cores and yokes being in juxtaposed relation with each other, the yokes being configured and located relative to the cores and windings so that the created magnetic flux corresponding to triplin harmonics is induced in and circulates within the yokes about the central axis.

A phase shifting three phase wye connected AC/DC fork transformer according to a further aspect of the present invention comprises three like transformer metal cores, each core having a top and a bottom, the cores each corresponding to a different phase of the transformer and arranged symmetrically about a central axis. A plurality of windings are wound about each core in a plurality of layers, a portion of each layer being spaced from the next adjacent layer forming a cooling duct with that next adjacent layer, the windings of each core being substantially identical to the windings of each other core, the windings of each core being symmetrically arranged relative to the windings of each other core about the axis, the windings on each core comprising a first clockwise and a second counterclockwise zig winding connected to each other at a junction, the first and second windings forming different layers and at least one central winding having one end coupled to the zig junction and its other end coupled to the same end of other central windings of each phase at a neutral point forming the fork transformer, the central winding forming a layer disposed between the zig winding layers, the plurality of windings on each core creating magnetic flux manifesting triplin harmonics. A yoke of magnetizable material is secured to each core at its respective top and a bottom. The cores and yokes are in juxtaposed relation with each other, the yokes being configured and located relative to the cores and windings so that the created magnetic flux of the triplin harmonics is induced in and circulates harmlessly within the yokes about the central axis; and a clamp for clamping the yokes to the cores, the cores being secured in substantial electrical conductive isolation relative to the yokes, the yokes being in magnetic field coupled relationship to the magnetic fields in said cores generated by said windings.

A phase shifting three phase wye connected AC/DC fork transformer according to an embodiment of the present invention comprises a plurality of like transformer magnetizable cores each having a top and a bottom, the cores each corresponding to a different phase of the transformer and arranged symmetrically about a central longitudinal axis.

A plurality of windings are wound about each core, the windings of each core being substantially identical to the windings of each other core, the windings of each core being symmetrically arranged relative to the windings of each other core relative to the axis, the windings on each core comprising clockwise and counterclockwise zig windings connected to each other at a junction, and at least one central winding having one end coupled to the zig junction and its other end coupled to the same end of other central windings of each phase at a neutral point forming the fork transformer, the plurality of windings on each core creating magnetic flux manifesting undesirable triplin harmonics.

A top yoke of magnetizable material is secured to each core at the core respective top and a bottom yoke of magnetizable material is secured to each core at the core respective bottom, the cores and yokes being in juxtaposed relation with each other, the yokes being configured and located relative to the cores and windings so that the created undesirable magnetic flux is induced in and circulates within the yokes about the central axis.

A three phase fork transformer according to another aspect of the present invention comprises a transformer having a minimum of four windings on each phase with two windings being connected in series to provide a tapped coil in which the end of the coil electrically furthermost from the tapping is connected to form a neutral with the same coils from another phase, the end electrically closest to the tapping in each phase being arranged to be connected to one of three power source lines, the same connections on each phase being such that each of the lines of the three phase source can be connected to each of the three different phase inputs of the transformer, one winding having one end connected in a counterclockwise direction to the power input terminal of the next phase, the other winding having one end connected in a clockwise direction to the next power input terminal. Included is an assembly comprising a plurality of symmetrical positioned cores and a yoke arrangement associated with cores, the cores and yoke arrangement being magnetically coupled to the windings and arranged to cause the flux of third harmonics generated by the windings to flow in the yoke arrangement.

A three phase fork transformer according to a still further aspect of the present invention comprises a transformer having a minimum of four windings on each phase with one winding being connected so that the one end of the winding is connected to form a neutral with the same winding from another phase, the other end of that winding in each phase being arranged to be connected as a first power input for connection to one of three power source lines, the same input connections on each phase being such that each of the lines of the three phase source can be connected to each of the three different phase inputs of the transformer.

A first pair of two windings are connected in series and have a tapping therein wherein the end furthermost from the tapping is connected in a counterclockwise direction to a second power input terminal of the next phase and the end closest to the tapping is connected to the first power input.

A second pair of two windings are connected in series and have a tapping therein wherein the end furthermost from the tapping is connected in a clockwise direction to a third power input terminal of the next phase and the end closest to the tapping is connected to the first power input. Included is an assembly comprising a plurality of symmetrical positioned cores and a yoke arrangement associated with cores, the cores and yoke arrangement being magnetically coupled to the windings and arranged to cause the flux of third harmonics generated by the windings to flow in the yoke arrangement.

### IN THE DRAWING

FIG. 1 is a circuit diagram showing a first embodiment of the present invention forming a three phase nine output transformer which may be used with a rectifier bridge to form an eighteen pulse transformer;

FIG. 2 is a rear elevation view of a transformer taken along lines 2-2 of FIG. 3 wound with windings depicted in FIG. 1 according to one embodiment of the present invention;

FIG. 3 is a top plan view of the embodiment of FIG. 2;

FIG. 4 is a front elevation view of the transformer of FIG. 3 taken along lines 4-4 with the optional terminal strip of FIG. 2 omitted for clarity of illustration;

FIG. 5 is a bottom plan view of the embodiment of FIG. 4 taken along limes 5-5;

FIG. 6 is an isometric view of a portion of a representative phase leg of the transformer with the windings and without the yokes attached showing the winding relationships of the different windings;

FIG. 7 is a sectional view of the embodiment of FIG. 2 taken along lines 7-7;

FIG. 7a is an isometric view of a representative spacer used to space the winding layers from each other in each leg to form cooling ducts;

FIGS. 8 and 9 are respective top plan and side elevation views, the latter taken at lines 8-8 of FIG. 8, of the top clamp assembly of the embodiment of FIGS. 2-5;

FIGS. 10 and 11 are respective top plan and side elevation views, the latter taken at lines 10-10 of FIG. 10, of the bottom clamp assembly of the embodiment of FIGS. 2-5;

FIG. 12 is an isometric view of a representative yoke used in the embodiment of FIGS. 2-5;

FIG. 13 is an isometric view of an optional representative core and yoke alignment bracket for each phase of the embodiment of FIGS. 2-5;

FIG. 14 is a side elevation view of the top yoke of FIG. 2 without the rest of the transformer structure illustrating the optional terminals used with the transformer of FIGS. 2-5;

FIG. 15 is a circuit diagram showing a second embodiment of the present invention forming a three phase nine output transformer which may be used with a rectifier bridge to form a twelve pulse transformer;

FIG. 16 is a circuit diagram showing a rectifier bridge to form the DC outputs of the twelve pulse transformer of FIG. 15; and

FIGS. 17 and 18 are respective circuit diagrams showing a further embodiment of the present invention forming a three phase twelve output transformer and a corresponding rectifier bridge to form a twenty-four pulse DC output; and

FIGS. 19 and 20 are respective circuit diagrams showing the embodiment of the present invention forming a three phase nine output transformer as shown in FIG. 1 and a corresponding rectifier bridge to form an eighteen pulse DC output.

### DETAILED DESCRIPTION OF THE PREFERRED EMBODIMENTS

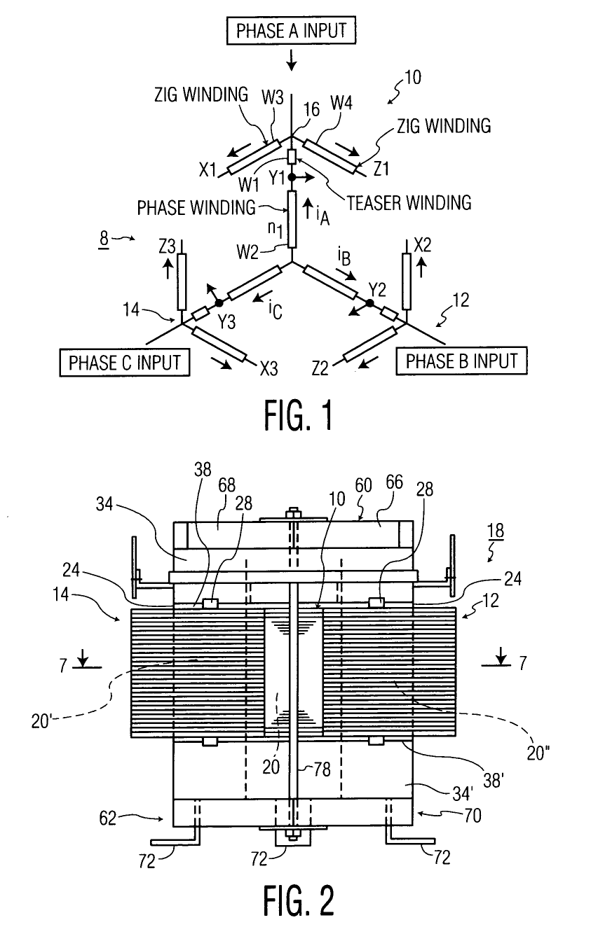

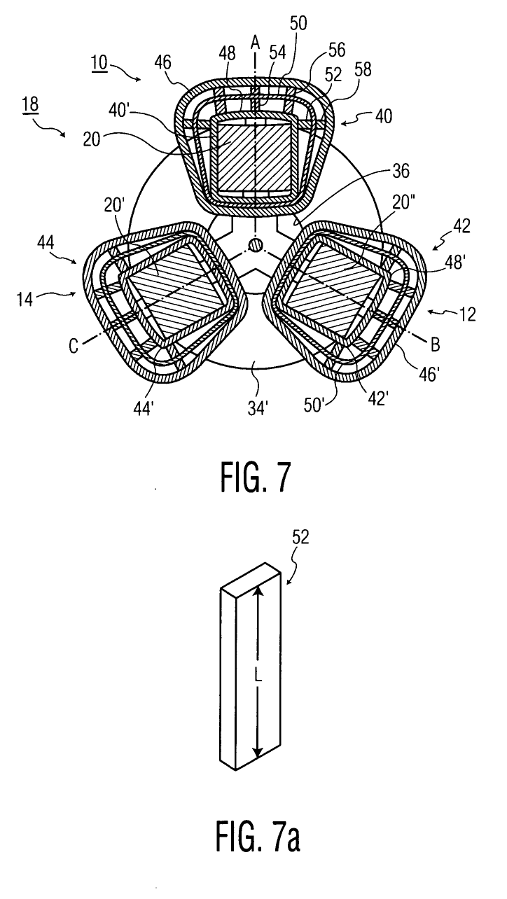

In FIG. 1, a phasor diagram 8 shows representative windings of a three phase fork AC/DC transformer. This diagram is identical to a diagram in the Paice patent mentioned in the introductory portion except this diagram has no delta winding as in the Paice diagram. In this diagram, the length of the rectangles representing windings represent the approximate relative length of the windings. The windings are arranged into three phases A, B and C at corresponding three legs 10, 12 and 14 of the physical construction of the transformer. The windings of each phase is identical to the windings of each of the other phases and a description of phase A is representative of the other phases. Phase A has a power input terminal 16 at the junction of clockwise zig winding w4 and counterclockwise zig winding w3 (referred to as a teaser winding in Paice). The terms “clockwise” and “counterclockwise” refer to the relative clock positions of the windings about the center of the diagram. A central winding comprises a relatively small winding w1 connected in series with a longer phase winding w2. w1 is referred to herein as a teaser winding and w2 is referred to herein as a phase winding. The nomenclature of the windings is a matter of choice as there are no set rules as to such nomenclature. The functions of the windings in FIG. 1 are the same as the functions of the windings in the Paice diagrams that are in the same relative diagram location, regardless the nomenclature assigned to the windings. The windings w1 and w2 are referred to by Paice as a long winding. The zig winding w4 is wound about the core of the phase B leg 12 in the clockwise direction and has one end connected to the power input of phase A and the other unterminated end forms an output terminal z1. The zig winding w3 is wound about the core of phase C in the counterclockwise direction and has one end connected to the power input of phase A and the other unterminated end forming an output terminal x1. The zig windings of each of the phases is wound in the identical manner. All of the zig windings of the different phases are identical to each other. All windings of each of the phases wound about the corresponding cores to be described below are matched in impedance to the windings of each other phase in a known way in this art. FIG. 1 corresponds generally to the phasor diagram of FIG. 7A of Paice and reference to this patent should be made for more complete description of these windings. The major and significant difference is that there is no delta winding in FIG. 1 as compared to Paice, FIG. 7A, which includes a delta winding. The other winding

embodiments of Paice may also be utilized in the alternative as desired for a given transformer implementation without the delta closed loop windings.

The windings w1 and w2 are connected in series with their interconnection forming a tapped point having an output y1. The other end of smaller winding w1 is connected to the power input terminal of phase A at the junction of zig windings w3 and w4. The other end of winding w2 is connected to a like end of the windings w2 of each of the phases A, B and C to form a neutral point.

In FIGS. 2-7, transformer 18 comprises three identical rectangular metal cores 20, 20′ and 20″ and which may be other geometrical shapes as desired, e.g., round or cylindrical, square and so on. A round cylindrical core is desirable because it requires less winding lengths and thus is lower in cost than planar surface cores. In FIG. 13, representative core 20 may preferably comprise a stack of sheet metal laminations as known in this art. The core 20 is rectangular in plan cross section shape. The core 20 has a longitudinal axis 22.

A first elongated yoke alignment bracket 24 on each leg is wedged to one outer surface 26, FIG. 13, of the corresponding leg core and the respective inner most winding 40′, 42′ and 44′ (zig winding w3) of respective windings 40, 42 and 44 of each leg, FIG. 6. Bracket 24 is made of glastic, a combination fiberglass, epoxy and plastic electrically insulating and magnetic field transparent material. This bracket is used to align the respective top and bottom yokes 34 and 34′ to the respective cores 20, 20′ and 20″ of the three legs. A second elongated glastic bracket 28 is at the opposite outer surface 30 of the core, is also wedged between the core and the innermost winding w3 of each leg and also used to align the yokes to the cores. The bracket 24 is narrower than bracket 28. The bracket 24 has a through hole 32 at each end beyond the plane of the core upper and lower respective surfaces 34, 36. The bracket 28 has two through holes 32 at each end. These holes are used to manipulate the brackets 24 and 28, either to move them or remove them as desired, after the yokes described below are assembled thereto, the brackets being optional. The brackets are held in place by the wedging action of the later wrapped windings as best seen in FIGS. 6 and 7. Each core 20, 20′ and 20″ preferably has an identical set of brackets 24 and 28, FIG. 7.

The cores 20, 20′ and 20″ are disposed in a symmetrical annular array 120° apart forming a Y format in plan view as seen in FIG. 7. The brackets 24 are radially outward of the cores and the brackets 28 are radially inward of the cores and extend beyond the cores in alignment with a portion of the top and bottom yokes. These extended portions receive the yokes in the space therebetween aligning the upper and lower yokes 34 and 34′ to the cores.

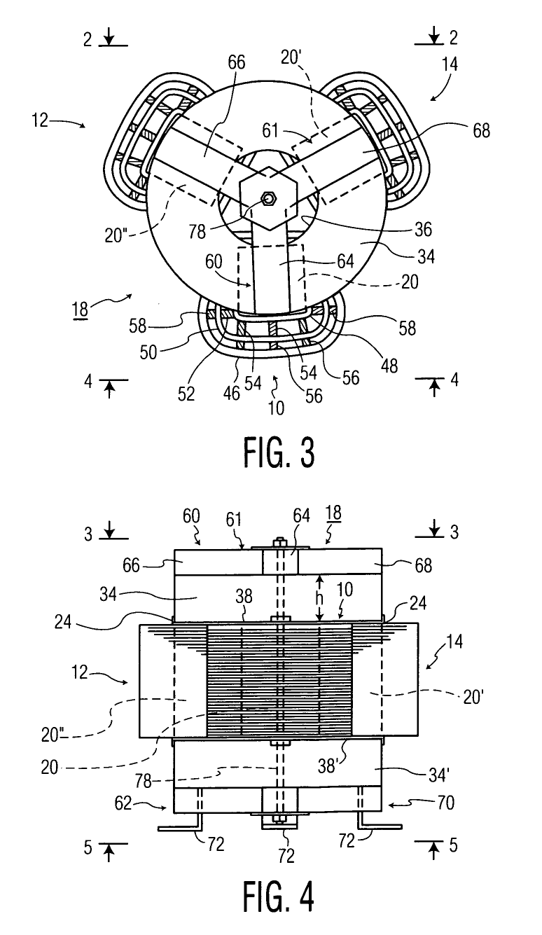

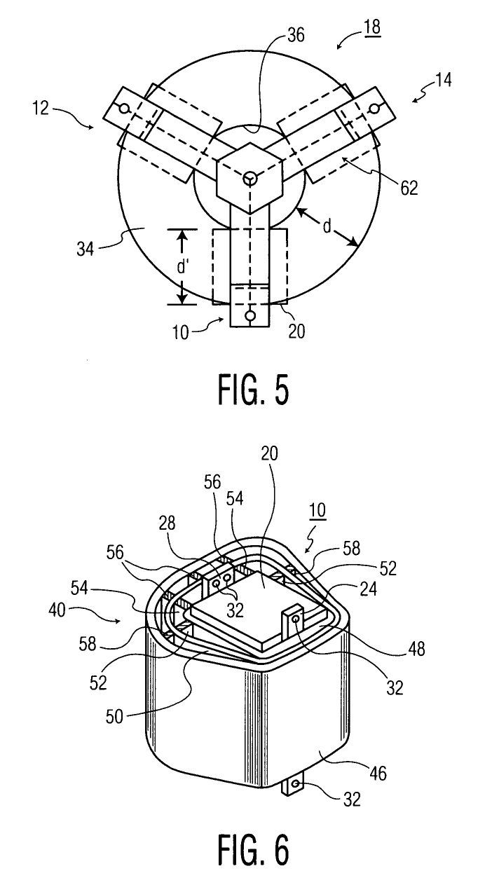

The brackets 24 and 28 are first assembled abutting the core 20 upright as shown, FIG. 13, with a portion protruding above and below the core 20. The space between the brackets 24 and 28 is just sufficient to receive the yoke 34 therein (FIGS. 2 and 4). This spacing serves to align the yokes with the cores. The yoke dimension d, FIGS. 3 and 5, is substantially the same as the dimension d′ of the yokes 34 and 34′, which yokes are identical. The dimension d′ of each of the cores 20, 20′ and 20″ of the array of cores defines an annular ring which receives and aligns the yokes 34 and 34′ thereto.

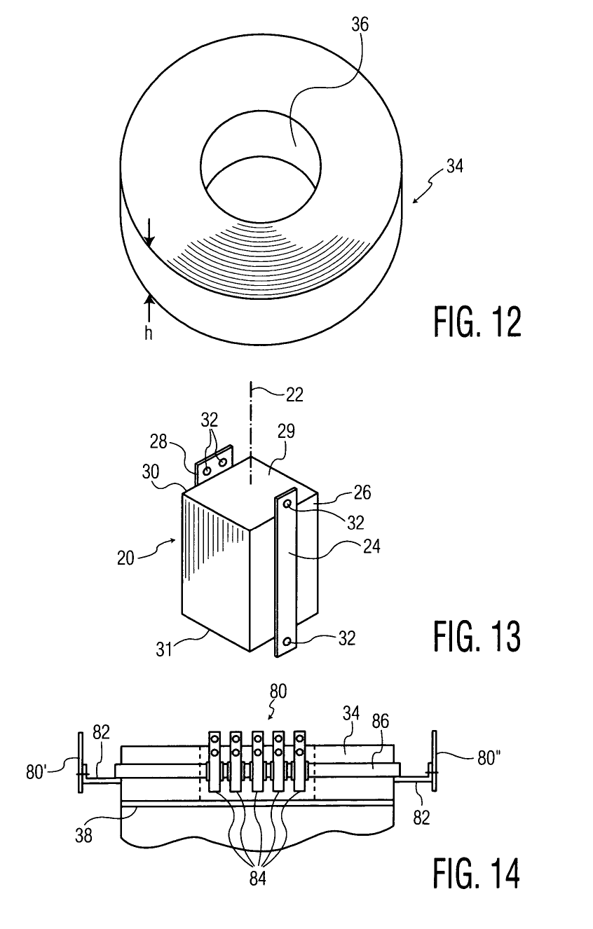

In FIGS. 2-5 and 12, top yoke 34 (and bottom yoke 34′ identical to top yoke 34) is a metal cylinder having a central bore 36. The yoke is toroidal. The yoke preferably is made of laminated magnetizable sheet metal such as steel and wound about a cylindrical form to form the toroid ring shape with overlapping layers. The yokes preferably have an ID formed by bore 36, FIG. 12, that is coextensive with the diameter of a circle that is tangent to the inner surfaces 26 (FIG. 13) of the cores 20, 20′ and 20″, FIG. 7, to which the brackets 24 are abutting. The yokes have an outer diameter (OD) that is coextensive with a circle that is tangent with the outer surface 30 (FIG. 13) of the cores to which the bracket 28 is abutting. This tangency of the yoke OD and ID is best seen in FIG. 7. Thus the yoke inner diameter (ID) minus its OD, dimension d, FIG. 5, is the same as dimension d′ of each of the cores. Dimension d′ is the radial dimension of the cores from surface 26 to surface 30, FIG. 13. The brackets 24 and 28 serve to align the yokes with the cores as explained. The dimension d of the yokes times the height of the yoke 34 (and yoke 34′), dimension h, FIGS. 4 and 12, is equal to the transverse cross sectional area of each of the cores 20, 20′ and 20″ (in a plane normal to the drawing sheet in FIGS. 2 and 4).

An electrically insulating sheet layer 38, FIG. 2, is between the yoke 34 and cores. The insulating layer 38 is washer-like in shape the same as the yoke 34 and is juxtaposed with the yoke 34. Layer 38 is preferably Nomex, a trademark of the Dupont corporation, for a callendered sheet of paper about 3 mils in thickness. In the alternative, an air gap may be used instead of layer 38. The layer 38 is electrically insulating and transparent to magnetic fields. The cores 20, 20′ and 20″ top surfaces 29 (FIG. 13) and yoke 38 facing bottom surface abut the layer 38. An insulating layer 38′ identical to layer 38 is between and abutting the cores 20, 20′ and 20″ bottom surface 31 (FIG. 13) and the facing surface of the bottom yoke 34′.

In FIGS. 3, 6 and 7, the windings 40 of the phase A leg 10 are wrapped about the core 20. Similarly, the windings 42 and 44 of the respective phase B and C legs are identical to each other and are wrapped in an identical manner about the corresponding cores 20″ and 20′ of each leg. Representative winding 40 has three layers of windings. The outer layer 46 comprises the wires of the clockwise zig winding w4 of phase C associated with the core 20 of leg 10. The innermost layer 48 comprises the wires of the counterclockwise zig winding w3 of phase B. The middle layer 50 comprises the wires of windings w1 and w2 forming the tapped (output y1, FIG. 1) phase A winding (the tapping not being shown in these figures). The windings 46, 48 and 50 are all wound in an identical direction about the respective core 20. The corresponding windings of each other legs are identical to and wound identically about each of the other respective cores 20′ and 20″. All windings of each of the legs are identical in gage and are sized to carry the expected currents in a manner calculated in a known manner to those of ordinary skill in this art. The windings of each leg are arranged to provide matched impedances in each leg as also known to those of ordinary skill in this art.

The innermost windings of layer 48 are wrapped directly about the core 20 and the brackets 24 and 28 wedging the brackets in place by the force of the windings. The terminations of the various windings are not shown in these figures. The middle winding layer 50 is wound about the innermost winding layer 48. The layer 50 is wound spaced from the winding layer 46 by winding about spacers 52 and 54 are made of glastic material. In FIG. 7a, representative spacer 52 is rectangular and elongated having a length L corresponding to the length of the core 20 (top to bottom of the drawing figure). The spacers 52 are identical and the spacers 54 are identical and all have the length L. The spacers may be about ⅜×½ inch, ¾×½ inch or ½×½ inch by way of example or may have other dimensions depending upon a given implementation. These spacers form cooling ducts between the innermost layer 48 and middle layer 50. The windings of layers 46 and 50 abut each other and layer 50 abuts the layer 48 windings on the radially innermost side of the core 20 adjacent to and facing bracket 24 I this embodiment due to the physical size of the cores and windings. In other larger embodiments, the windings may be spaced from each other to form cooling ducts at all sides of the cores. The windings 48 and 50 adjacent to the core 20 bracket 28 have the greatest spacing therebetween.

The outermost winding layer 46 is spaced from the middle layer 50 by spacers 56 and 58. Spacers 56 may be dimensioned the same as spacers 54 and spacers 58 may be dimensioned the same as spacers 52. However, the spacers may also differ in relative sizes from that shown according to a given implementation. The drawings of the various figures are not to scale. Thus cooling ducts are provided between the outer layer 46 of windings and the middle layer 50. All of the spacers are made of the same material and have the same general shape as spacer 52, FIG. 7a. All of the legs are wound in identical fashion as described with respect to leg 10. The windings of each layer are all wound in the same direction in each leg. The legs are thus symmetrical as much as possible in all ways. Any change of configuration of one leg needs to be identical to each other leg to provide matched impedences for all of the legs.

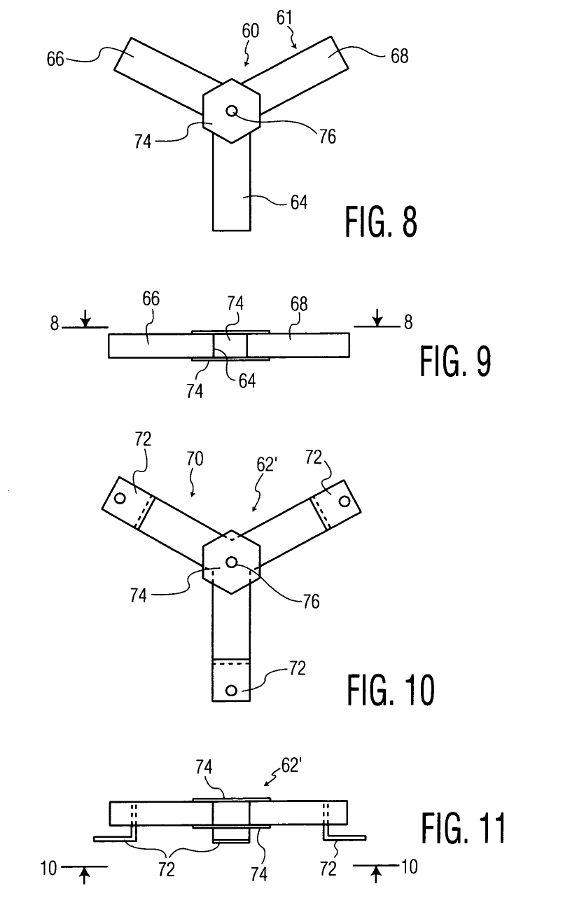

In FIGS. 2-5 and 8-11, the yokes, insulating layers and legs with the windings on the cores are clamped together by clamp assembly 60 at the top of the transformer 18 and clamp assembly 62 at the bottom of the transformer 18. Clamp assembly 60 includes a Y-shaped clamp 61 having three identical legs 64, 66 and 68 each identically arcuately spaced apart 120° to match the spacing and orientation of the transformer 18 legs 10, 12 and 14. The clamp legs 64, 66 and 68 are each juxtaposed with and aligned centrally in a circumferential direction with a corresponding transformer leg 10, 12 and 14. The clamp 61 is preferably formed from three identical U-shaped steel channels forming each of the three legs of the clamp. The channels each have planar sides and bottom walls welded or otherwise joined together at the central junction of the three legs 64, 66 and 68. In the alternative, the legs 64, 66 and 68 of the clamp 61 may be formed of hollow square or rectangular steel tubing. The legs may also be formed of sheets of steel welded together to form the channels or tubing. The configuration of the clamp 61 may differ according to a given implementation.

The bottom clamp assembly 62 has a clamp 70 that is substantially the same as clamp 61 except the clamp 70, in addition, has transformer support feet 72 welded to each of the clamp 70 legs, FIGS. 2 and 4. Feet 72 are L-shaped brackets wherein one leg of the L forms the support foot and the other normal leg is welded or bolted to a corresponding leg of the clamp 70. The upper clamp assembly 60 also includes two sheet steel planar washers 74, 74′, the former on top of and the latter underneath the Y-shaped clamp 61. The washers may be any shape and are shown as hex shaped by way of example. They could be round, square, rectangular and so on. The washers 74 and the clamp 61 have a central bore 76, FIG. 9. The lowermost washer 74′, FIG. 9, is located in the bore of the upper yoke 34, FIGS. 2 and 4. Identical washers 74 and 74′ are associated with the lower yoke 34′. The upper washer 74 of the lower clamp assembly 62′ is located in the bore of the lower yoke 34′. The washers serve as support and reinforcement gussets for the legs of the Y-shaped clamps 61 and 70. A long bolt 78, FIGS. 2 and 4, is located in the central bore 76 of the washers and clamps. The bolt 78 clamps the clamp assemblies 61 and 70 to the yokes and the yokes to the cores via nuts at the threaded ends of the bolt 78. While a single bolt is used in this embodiment, more bolts attached to each leg of the clamps at their outer edges may also be used for large transformers.

In FIG. 14, an optional termination strip assembly 80, 80′ and 80″ is attached to the outer surface of the top yoke 34 at each phase leg 20, 20′ and 20″. Assembly 80 is representative of the identical assemblies and includes five copper rectangular strips 84 attached to a U-shaped glastic insulation support 82. The strips 84 are configured to receive and be connected to wire conductors to which the outputs of the transformer are to be connected. The supports 82 are attached to the outer peripheral surface of the top yoke 34 by a steel band 86.

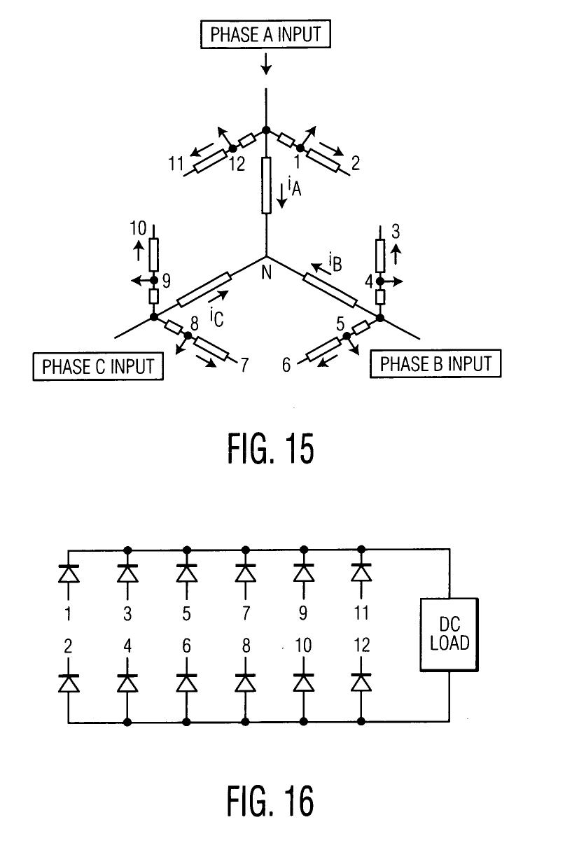

FIG. 15 is a phasor diagram representing a twelve pulse transformer having twelve outputs 1-12. This diagram corresponds to the diagram FIG. 3A of the Paice patent noted in the introductory portion. Reference to that patent should be made for further description of this diagram. However, like FIG. 1 herein, there is no delta winding as is in the Paice patent FIG. 3A. FIG. 16 is a rectifier bridge circuit also shown in FIG. 3A of the Paice patent and used to generate the twelve pulse output at the DC load.

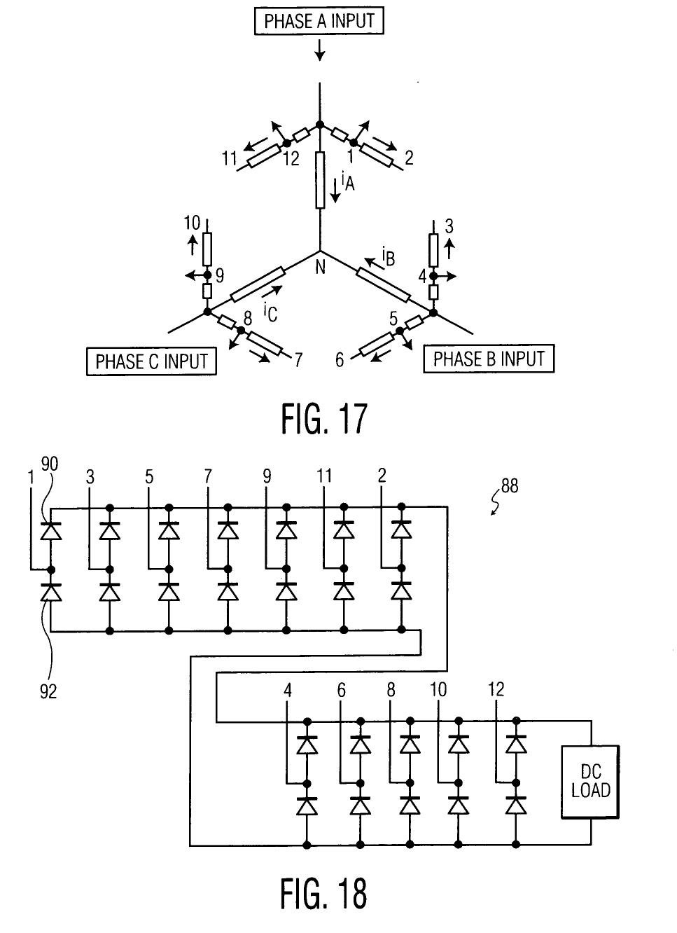

FIG. 17 is a phasor diagram similar to that of FIG. 15, but coupled to a rectifier bridge 88, FIG. 18, as a twenty four pulse transformer. The rectifier bridge 88 is coupled to the twelve outputs of the circuit of FIG. 17 as shown. The outputs of FIG. 17 are labeled 1-12. The bridge comprises 12 pairs of diodes 90, 92 connected in series with each other and in parallel to each of the other pairs. Each transformer output is connected to the anode-cathode junction between each of the series connected diodes 90, 92. The output comprises twenty four pulses of DC current applied to the DC load.

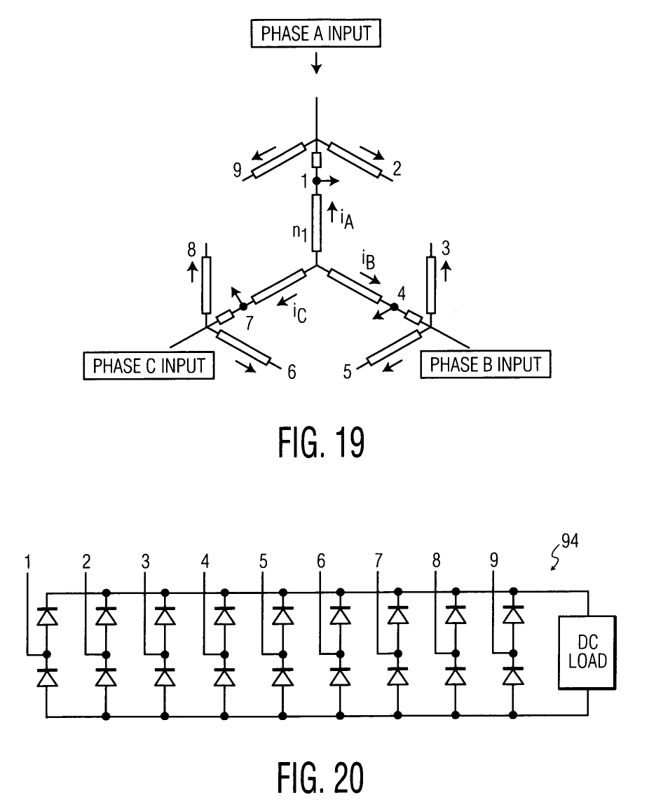

FIG. 19 is a phasor diagram which is the same as that of FIG. 1. Its outputs are labeled 1-9. These outputs are connected to the rectifier bridge 94, FIG. 20, to produce an eighteen pulse output current to the load. Presently, eighteen pulse prior art transformers are in wide use. Twenty four pulse transformers have tradeoffs including more components and thus are more costly to implement.

Thus there has been disclosed preferred and alternative embodiments of a transformer construction of the fork type wherein a minimum of four windings can be used per phase in comparison to a minimum of five windings as used in the prior art which require a closed loop unconnected delta winding not required in the transformers of the present invention. The delta winding provided a path in which third harmonic currents and multiples thereof could flow.

The transformer of the present invention has improved performance with regard to reduced total harmonic distortion on the input lines and requires only four windings per leg or phase. The flux of the third harmonics and multiples thereof is circulated through the yokes by use of symmetrically oriented legs of the three phases so that magnetic flux can flow through each individual core leg and circulate in the yokes. A round or toroidal yoke is preferably used because less stress is placed on the sheet steel forming the yoke when winding the sheets of steel about a round form compared to tighter smaller bends that may result in triangular or other shapes at the corners of such shapes. Yokes of such other shapes however may also be used according to a given implementation. What is required is that the yoke be able to circulate the flux in an annular path and any shape yoke which permits this flux flow is acceptable for this purpose. However, the round yoke yield of lower stress on the steel forming the yoke results in lower yoke core losses, eliminates the need to anneal the steel after winding the yoke, and effectively produces a more efficient yoke core.

In a nine phase transformer, the windings of the autotransformer are interconnected between phases in a manner that results in nine phase voltages that are symmetrically displaced from each other as shown in FIG. 19 for example. The primary purpose, however, is to provide power to 12, 18, or 24 pulse AC/DC converters while mitigating or minimizing total harmonic distortion present on the input power lines. The transformer of the present invention accomplishes this result by eliminating the even harmonics via the insulating layers 38, 38′ and the third harmonics and multiples thereof, i.e., the triplin harmonics, via the transformer configuration as described herein. Thus acceptable total harmonic distortion levels are provided without input line reactors and output line reactors typically required for prior art transformers.

The insulating layers 38, 38′ provide a high reluctance path, inherent to the construction of the transformer disclosed above due to the gap between the cores of each leg and the top and bottom yokes. Additionally, the grain orientation of the steel in the cores of the legs is perpendicular to the yokes. The combination of this grain orientation and the gap between the cores and yokes results in a reluctance higher than that of three phase, shell type cores, which historically have been built for third harmonic circulation. An added benefit of the gaps between the cores of each leg and the yokes is the elimination of the even harmonics that are common to the rectifier circuits of the prior art. The provision of a path for the flux of the third harmonics and multiples thereof permits the flux to circulate harmlessly and prevents these harmonics from being transmitted to the incoming lines, and out to the power distribution system. These harmonics can have detrimental effects on equipment being used with the power system and can result in lower efficiencies and higher operating costs. The transformer of the present invention accomplishes these advantages without the prior art closed unconnected delta winding which also adds to the cost of transformers.

It will occur to those of ordinary skill that the disclosed embodiments may be altered to provide still further embodiments, the invention being not limited to the disclosed embodiments. It is intended that the invention be defined by the appended claims.

What is claimed is:

1. A phase shifting three phase wye connected AC/DC fork transformer comprising:
a plurality of like transformer magnetizable cores each having a top and a bottom, the cores each corresponding to a different phase of the transformer and arranged symmetrically about a central longitudinal axis;
a plurality of windings wound about each core, the windings of each core being substantially identical to the windings of each other core, the windings of each core being symmetrically arranged relative to the windings of each other core relative to the axis, the windings on each core comprising clockwise and counter clockwise zig windings connected to each other at a junction, and at least one central winding having one end coupled to the zig junction and its other end coupled to the same end of other central windings of each phase at a neutral point forming a fork transformer, the plurality of windings on each core creating magnetic flux manifesting undesirable triplin harmonics; and
a top yoke of magnetizable material secured to each core at the core respective top and a bottom yoke of magnetizable material secured to each core at the core respective bottom, the cores and yokes being in juxtaposed relation with each other, the yokes being configured and located relative to the cores and windings so that the created undesirable magnetic flux is induced in and circulates within the yokes about the central axis.

2. The transformer of claim 1 wherein the yokes are electrically isolated from the cores.

3. The transformer of claim 1 wherein the yokes are metallic circular cylinders with a hollow central region.

4. The transformer of claim 1 wherein the cores are blocks of metal.

5. The transformer of claim 4 wherein the cores comprise multiple lamination sheets secured together.

6. The transformer of claim 1 wherein each core defines a leg corresponding to one phase of the transformer, the legs extending radially outwardly from the central longitudinal axis in 120° relative spacing to each other.

7. The transformer of claim 1 including top and bottom Y-shaped clamps for clamping the yokes to the cores between the clamps.

8. The transformer of claim 1 wherein one zig winding is wrapped about a corresponding core, the central winding being wrapped about the one zig winding and a second zig winding being wrapped about the wound central winding.

9. The transformer of claim 8 wherein the one and second zig windings are supported in spaced relation from the central winding in at least a portion of each winding about the corresponding core to form cooling ducts between the one, the second and the central windings.

10. The transformer of claim 9 including a winding support structure coupled to each corresponding core for supporting the one, second and central windings in the spaced relation in each phase.

11. The transformer of claim 1 wherein the zig and central windings are wrapped about the corresponding core of each phase in one or more layers.

12. The transformer of claim 1 wherein all windings of each phase have a matched impedance with respect to the impedance of the corresponding windings of each other phase.

13. The transformer of claim 1 including a clamp system for clamping the yokes to the cores.

14. The transformer of claim 13 wherein the clamp system comprises upper and lower wye shaped clamps secured together by a central bolt, the yokes and cores being located between the clamps wherein the clamps each have a radially outwardly extending leg from a common central junction, a top clamp leg being juxtaposed, aligned with and corresponding to a bottom leg of each phase and with a corresponding core of that phase.

15. The transformer of claim 1 including a power input terminal at said junction in each phase.

16. The transformer of claim 1 wherein the central winding of each phase forms a tapped coil comprising series connected teaser and phase windings with an output terminal connected to a tapping between the teaser and phase windings.

17. The transformer of claim 16 wherein each zig winding at an end furthest from the junction is connected to an output terminal forming three output terminals in each phase and a nine output terminal transformer.

18. The transformer of claim 1 wherein each zig winding comprises a tapped coil of series connected first and second windings with a tapping therebetween connected to an output terminal, the end of each zig winding furthest from the junction being connected to a further output terminal forming a twelve output terminal transformer.

19. The transformer of claim 18 further including a rectifier bridge connected to said twelve output terminals forming a twelve pulse transformer.

20. The transformer of claim 18 further including a rectifier bridge connected to said twelve output terminals forming a twenty four pulse transformer.

21. The transformer of claim 17 further including a rectifier bridge connected to said nine output terminals forming an eighteen pulse transformer.

22. The transformer of claim 1 wherein each core has a longitudinal axis passing through said top and bottom yokes, each core having planar sides and forming a geometrical figure at its outer peripheral surface in a direction transverse to its longitudinal axis.

23. The transformer of claim 1 including first and second members attached to each core and to the top and bottom yokes for securing the cores to the yokes.

24. The transformer of claim 23 including top and bottom clamps for clamping the yokes to the cores each including a Y-shaped clamp member, a washer overlying the clamp member and a central bolt for clamping the washer, clamp members, yokes and cores together.

25. A phase shifting three phase wye connected AC/DC fork transformer comprising:
three like transformer metal cores, each core having a top and a bottom, the cores each corresponding to a different phase of the transformer and arranged symmetrically about a central axis;
a plurality of windings wound about each core in a plurality of layers, a portion of each layer being spaced from the next adjacent layer forming a cooling duct with that next adjacent layer, the windings of each core being substantially identical to the windings of each other core, the windings of each core being symmetrically arranged relative to the windings of each other core about the central axis, the windings on each core comprising a first clockwise, relative to the central axis, and a second counterclockwise, relative to the central axis, zig winding connected to each other at a junction, the first and second windings forming different layers and at least one central winding having one end coupled to the zig junction and its other end coupled to the same end of other central windings of each phase at a neutral point forming the fork transformer, the central winding forming a layer disposed between the zig winding layers, the plurality of windings on each core creating magnetic flux manifesting triplin harmonics;
a top yoke of magnetizable material secured to each core at its respective top and a bottom yoke of magnetizable material secured to each core at its respective bottom, the cores and yokes being in juxtaposed relation with each other, the yokes being configured and located relative to the cores and windings so that the created triplin harmonics magnetic flux is induced in and circulates harmlessly within the yokes about the central axis; and
a clamp for clamping the yokes to the cores, the cores being secured in electrical isolation to the yokes, the yokes being in magnetic field coupled relationship to the magnetic fields in said cores generated by said windings.

26. A three phase fork transformer comprising:
a symmetrical wye arrangement of three like transformer cores;
a plurality of windings associated with each core forming a fork transformer with the cores; and
top and bottom yokes secured to respective corresponding opposite top and bottom ends of each of the cores, the yokes being coupled to the windings and cores to receive and circulate therein third harmonic triplin generated fields generated by the windings and cores.

27. A three phase fork transformer comprising:
a transformer having a minimum of four windings on each phase with two windings being connected in series to provide a tapped coil in which the end of the coil electrically furthermost from the tapping is connected to form a neutral with the same coils from another phase, the end electrically closest to the tapping in each phase being arranged to be connected to one of three power source lines, the same connections on each phase being such that each of the lines of the three phase source can be connected to each of the three different phase inputs of the transformer, one winding having one end connected in a counterclockwise direction to the power input terminal of the next phase, the other winding having one end connected in a clockwise direction to the next power input terminal; and
an assembly comprising a plurality of symmetrical positioned cores and a yoke associated with cores, the cores and yoke being magnetically coupled to said windings and arranged to cause the flux of third harmonics generated by said windings to flow in the yoke.

28. A three phase fork transformer comprising:
a transformer having a minimum of four windings on each phase with one winding being connected so that the one end of the winding is connected to form a neutral with the same coils from another phase, the other end of that winding in each phase being arranged to be connected as a first power input for connection to one of three power source lines, the same connections on each phase being such that each of the lines of the three phase source can be connected to each of the three different phase inputs of the transformer;
a first pair of two windings being connected in series and having a tapping therein wherein the end furthermost from the tapping being connected in a counterclockwise direction to a second power input terminal of the next phase and the end closest to the tapping being connected to the first power input;
a second pair of two windings being connected in series and having a tapping therein wherein the end furthermost from the tapping being connected in a clockwise direction to a third power input terminal of the next phase and the end closest to the tapping being connected to the first power input; and
an assembly comprising a plurality of symmetrical positioned cores and a yoke associated with cores, the cores and yoke being magnetically coupled to said windings and arranged to cause the flux of third harmonics generated by said windings to flow in the yoke.
